(19) United States
(12) Patent Application Publication
(10) Pub. No.: US 2010/0162966 A1
(43) Pub. Date: Jul. 1, 2010

(54) Apparatus and method for tethering a companion animal close to a human being for improved control of said companion animal

(76) Inventor: Shannon McFarland, Ventura, CA (US)

Correspondence Address: SANDRA LEE LIPKIN A LAW CORPORATION, P.O.Box 3518, VENTURA, CA, 93006, US

(21) Appl. No.: 12/317,981

(22) Filed: Dec. 31, 2008

(51) Int. Cl. A01K 27/00; A01K 29/00

(52) U.S. Cl. 119/794; 119/858; 119/161

(57) ABSTRACT

An apparatus and method for tethering a companion animal close to a human being primarily as a means to avoid fines associated with untethered animals as well as a way to calm members of the public who may be fearful of an untethered animal, not knowing whether the animal is well-behaved or not. The tethering device of the instant invention cannot be used as a leash or restraining device. Accordingly, the instant invention seeks not to provide a retractable leash for an animal, but rather to provide a means of tethering the animal to the owner for owners with controllable animals who need to be tethered to be in compliance with local ordinances requiring the tethering of companion animals.

### BACKGROUND OF THE INVENTION

1. Field of the Invention

The present invention relates generally to the field of dog collars and particularly toward a dog collar that incorporates a tethering device not meant to be used as a leash, but rather as a way to tether a dog (or other companion animal) to its human companion as a way to avoid citations from local authorities for having an untethered dog and to calm the fears of members of the public who might be fearful of an untethered animal.

2. Description of the Prior Art

Humans with companion animals, such as dogs, are familiar with dog collars and leashes. A dog wears a collar or other harness as a way to keep identification tags on the dog. Also, a dog collar can be attached to a leash that the owner can then use to control the dog for taking walks and limiting the dog's movement through attachment to the human or other stationary object. Dog collars that incorporate retractable leashes thereon are known in the art. These devices however are bulky and impractical. In order to have a retractable collar strong enough to restrain such a large dog, a massive device would need to be attached to the dog's collar.

Many people have dogs that are well-behaved that can be controlled by the command's of the dog's human companion. Dogs such as these do not necessarily need the restraint of a leash to be kept under control. However, most municipalities have ordinances that require that a dog be kept on a leash in public places. Furthermore, members of the public often are fearful of untethered dogs, regardless of whether or not the animal is well-behaved as strangers are not privy to such information.

For the owners of such well-behaved and controllable dogs, these ordinances can cause the collection of fines that are unwarranted precisely because the owner responsibly keeps the dog under control through commands rather than a leash. The purposes of these ordinances are to protect the public from uncontrollable dogs. There exists a problem for the owner of a well-trained dog who can control the dog, thereby not jeopardizing the safety of the public at large, but who is restrained by the laws requiring leashes in public places.

The instant invention seeks to solve the problem caused by the conflict faced by such owners of controllable dogs who want to let the dog move around freely yet not violate any of the laws requiring the leashing of dogs. Controllable dogs who enjoy the freedom of being unleashed can now be tethered to their owners as needed by providing a small device on the collar that can tether the dog to its owner. The tether, however, is of insufficient strength to act as a leash for animals.

### SUMMARY OF THE INVENTION

The preferred embodiment of the present invention teaches a system for tethering a companion animal to a human being comprising a collar for placement around the neck of the companion animal; a means for securely enclosing the collar around the neck of the companion animal; and a tethering device that allows for the quick release of a tether connecting the companion animal to the human being.

The above embodiment can be further modified by defining that the tethering device further comprises an outer casing; an inner casing, the inner casing having a depression for the placement therein of a retractable coiled line; and a grabable portion attached to the retractable coiled line wherein the grabable portion does not retract back into the inner cashing when the coiled line is not in use.

The above embodiment can be further modified by defining that the tethering device is made of material that withstands environmental extremes.

The above embodiment can be further modified by defining that a safety light is attached to the collar for safe use in dark times and places.

The above embodiment can be further modified by defining that a bag for the collection of dog waste is attachable to the collar.

### BRIEF DESCRIPTION OF THE DRAWINGS

This invention can better be understood by reference to the drawings, provided for exemplary purposes, and in which:

FIG. 1 is a perspective view of the collar of the instant invention that incorporates a tether that is small and convenient for the use described herein.

FIG. 2 is an exploded view of the retractable line of the instant invention.

FIG. 3 is a side view of a dog owner with his dog next to him, untethered.

FIG. 4 is a side view of a dog owner with his dog next to him, tethered.

### DETAILED DESCRIPTION OF A PREFERRED EMBODIMENT

The instant invention seeks to provide a means of tethering a controllable dog to its human companion in order to avoid citation by local authorities. Such tethering means is a small tether that is retractable and attachable to the dog's collar. The tethering means is small in size for the convenience of attaching to the dog collar. However, due to its small size, the tethering means is not suitable for restraining animals. The purpose of the apparatus is to prevent the issuance of citations for having these controllable dogs untethered and as such can be used for dogs of all sizes. The device also serves to calm members of the public who may be fearful of an untethered animal, no knowing whether or not the animal is well-behaved or not.

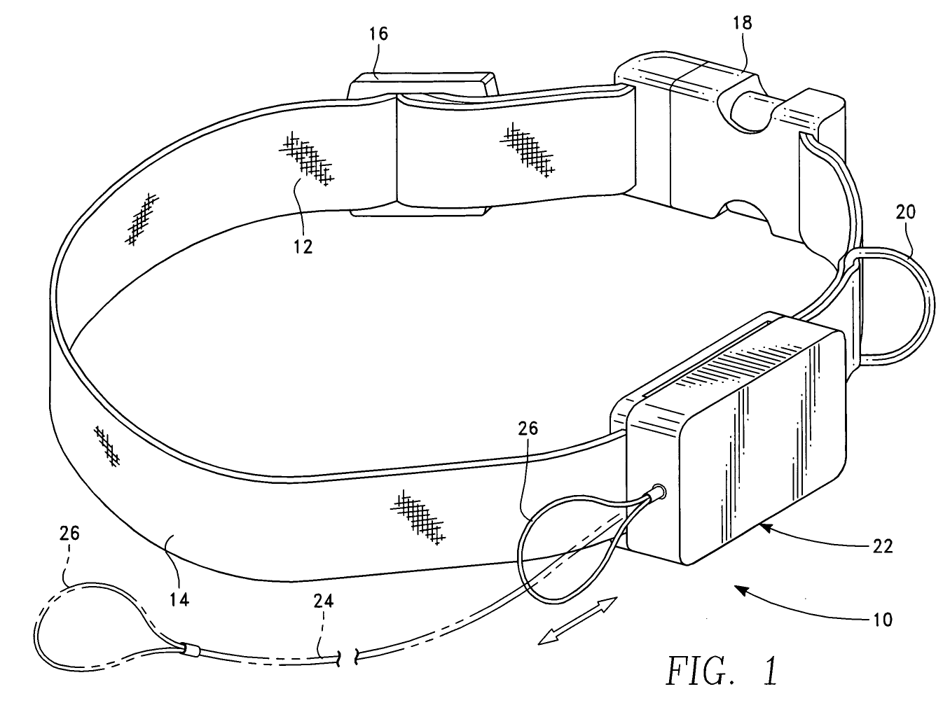

FIG. 1 depicts a perspective view of the instant invention. The instant invention is a dog collar 10 with an interior face 12 and an exterior face 14. The collar 10 can be adjustable through an adjustable mechanism 16 well known in the art. The collar can attach in any way known the in the art. Shown here is a depressable connection system 18.

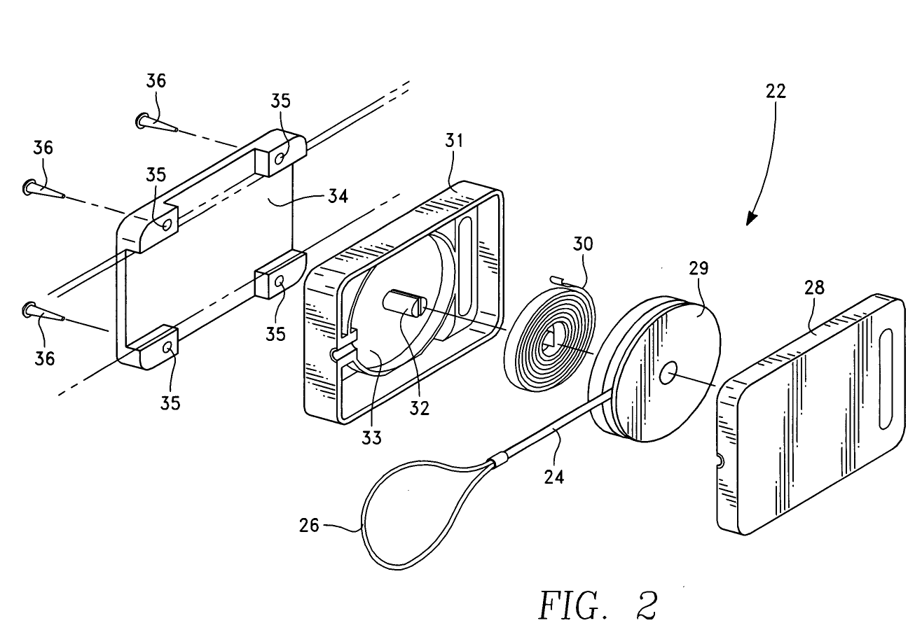

The collar 10 can also include a D-loop 20 for the attachment of a proper leash, if desired. The novelty in the invention is found in the retractable device 22 that is attached to the collar 10 and secured to both the interior face 12 and the exterior face 14. The retractable device 22 has an interior portion that houses the tether 24 when not in use (see FIG. 2).

The tether 24 terminates in a grabable end 26 that the human companion can easily access as needed to create a tethered line between the human companion and the dog.

The retractable device 22 can be made of a waterproof and durable material that can withstand environmental extremes and have the ability to lock in the retracted position. The collar can also include an optional safety light for night-time use and for use in dark places.

Seen in FIG. 2 is an exploded view of the retractable device 22. The device is housed within a casing 31 that includes a top face 28 and a back face 34. The back face includes four holes 35 through which screws 36 pass attaching the back face 34 first to the casing 31 and finally to the front face 28.

Inside the casing is a space 33 that is round and that contains a post 32 in the center. A coil 30 wraps around the post 32 and the coil 30 attaches to casing 29 that houses the tether 24. The mechanics of the of the tethering device 22 are not claimed as the novelty of the invention, but are illustrated here for clarity.

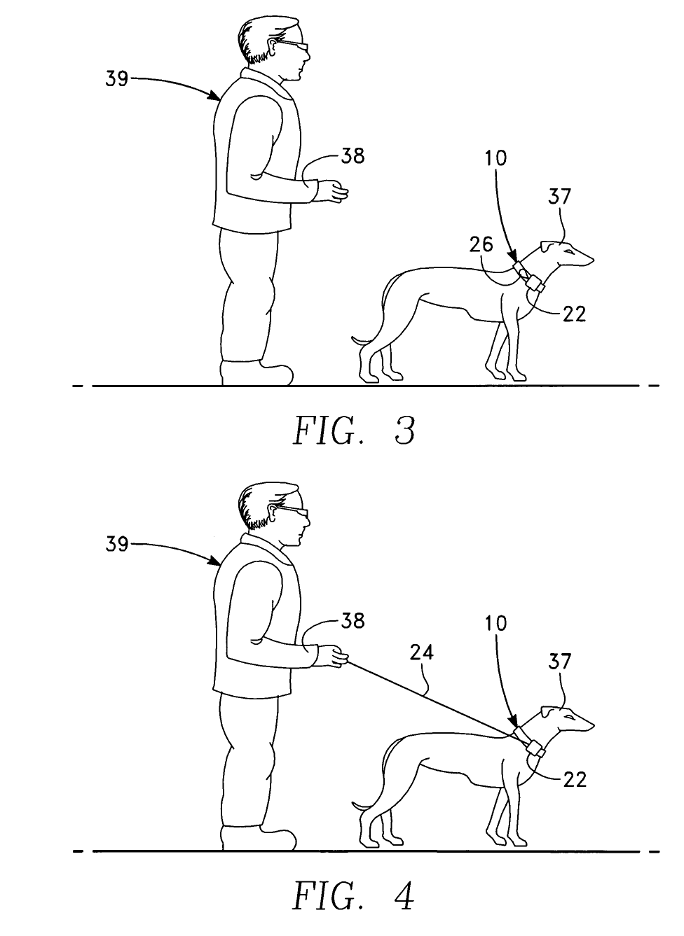

FIGS. 3-4 show the method of using the instant invention. A dog owner 39 stays near his dog 37 who wears the collar 10 containing the tethering device 22. When it becomes important for the dog 37 to be tethered to the owner 39, the owner 39 grabs the tether 24 which connects the owner's arm 38 to the dog 37 through the tethering device 22 attached to the collar 10.

The illustrations and examples provided herein are for explanatory purposes only and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

1. A system for tethering a companion animal to a human being comprising
a means for attaching a leash to a collar; and
a tethering device attachable to said attaching means that allows for the quick release of a tether connecting said companion animal to said human being.

2. The system as defined in claim 1 wherein said tethering device further comprises
an outer casing;
an inner casing, said inner casing having a depression for the placement therein of a retractable coiled line; and
a grabable portion attached to said retractable coiled line wherein said grabable portion does not retract back into said inner cashing when said coiled line is not in use.

3. The system as defined in claim 1 wherein said tethering device is made of a material that can withstand environmental extremes.

4. The system as defined in claim 1 wherein a safety light is attached to said collar.

5. The system as defined in claim 1 wherein a bag for the collection of dog waste is attachable to said collar.
